(19) United States
(12) Patent Application Publication
(10) Pub. No.: US 2022/0339796 A1
(43) Pub. Date: Oct. 27, 2022

(54) MOUNTING ARRANGEMENT FOR MULTI-FUNCTIONAL ARM

(71) Applicant: BILSING AUTOMATION GMBH, Attendorn (DE)

(72) Inventor: Alfred BILSING, Attendorn (DE)

(21) Appl. No.: 17/238,998

(22) Filed: Apr. 23, 2021

(51) Int. Cl. B25J 15/04; H01R 31/06; B25J 19/00

(52) U.S. Cl. CPC B25J 15/0408; H01R 31/06; B25J 19/0029

(57) ABSTRACT

An arm engageable with a mounting receiver of an automated tooling system. The arm comprises a wall defining a central bore extending the length of the arm, and at least pin engageable with the mounting receiver to engage the mounting receiver for aligning and receiving the mounting receiver. The pin may be a plasma ion nitrided pin. The arm may also include first and second ends, an electrical power supply connector positioned inside the bore adjacent the first end and wiring. The second end defines an opening. The wiring is connected to the electrical power supply connector, and extends unexposed within the bore from the electrical power supply connector through the opening to supply power to the gripper.

### BACKGROUND

The present invention relates generally to an arm engageable with a mounting receiver of a mounting assembly of an automated tooling system.

The prior art methods of mounting of an arm to a mounting receiver of an automated tooling system have shortcomings because, among other reasons, the connectability of the two components can be clumsy and does not tend to be quick, easy and efficient. Further shortcomings include a short life of the arms because the plasma ion nitrided pins of the arms can break which affects the ease of connectability. When the plasma ion nitrided pins break, the plasma ion nitrided pins or possibly the arms need to be replaced.

### SUMMARY

This disclosure is directed to an arm engageable with a mounting receiver of an automated tooling system having a gripper. The arm comprises a wall defining a central bore extending the length of the arm, and at least pin engageable with the mounting receiver to engage the mounting receiver for aligning and receiving the mounting receiver. The pin may be a plasma ion nitrided pin. The arm may also include a first end, a second end, an electrical power supply connector positioned inside the bore adjacent the first end, an electrical exit port disposed at the second end and wiring. The wiring is connected to the electrical power supply connector and the electrical exit port, extending unexposed within the bore from the electrical power supply connector to the electrical exit port, to supply power to the gripper. The arm may include a protective tube disposed at the second end about the electrical exit port. The arm further includes a collar, and the plasma ion nitrided pin is secured to the collar.

These and other features of the present invention will be best understood from the following drawings and detailed description.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 is a perspective view of an automated tooling system;

FIG. 2 is a perspective view of the arm of the automated tooling system of FIG. 1 engaging with the mounting receiver of the automated tooling system of FIG. 1;

FIG. 3 is a perspective view of the arm of FIG. 2;

FIG. 4 is a top plan view of the arm of FIG. 2;

FIG. 5 is a plan view of the rear of the arm of FIG. 2; and

FIG. 6 is a partial cross sectional view taken along line 6-6 of FIG. 3.

### DETAILED DESCRIPTION

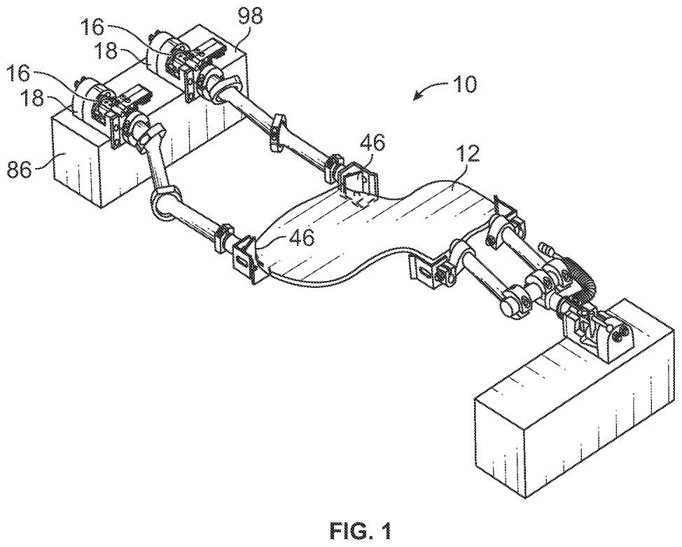

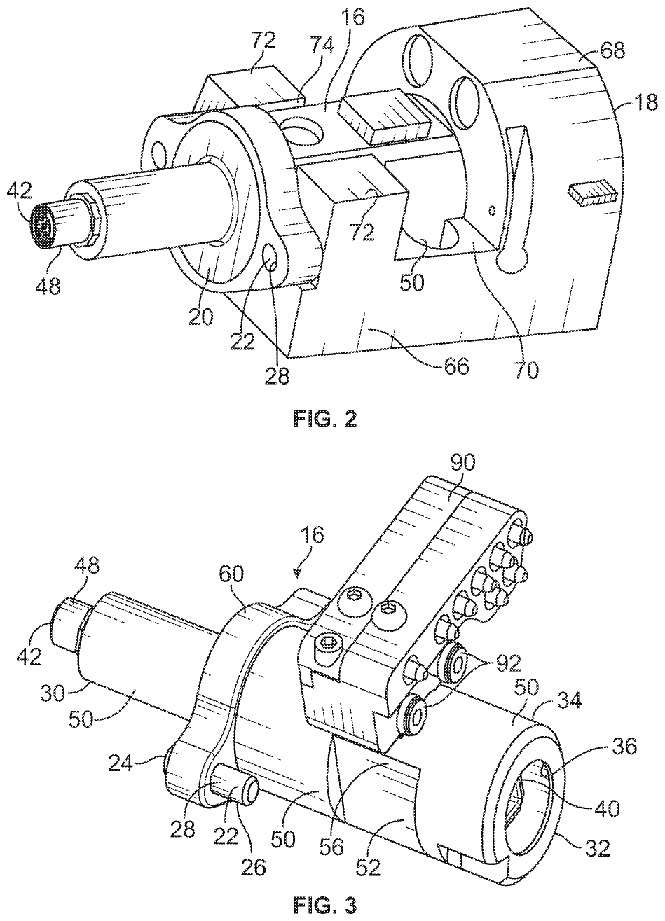

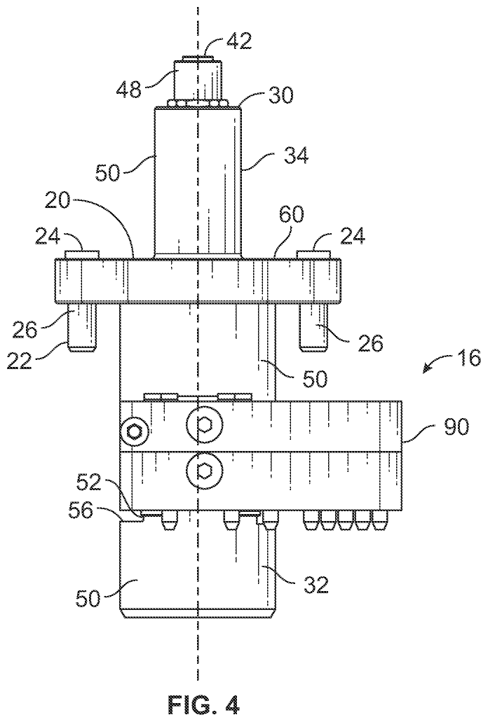

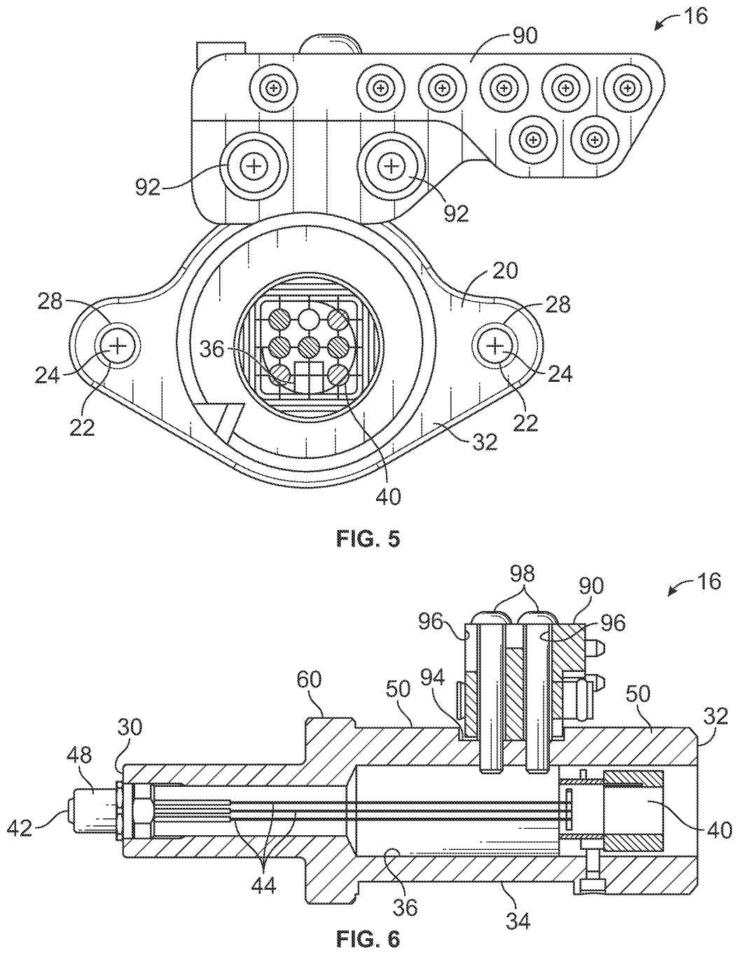

FIGS. 1-6 illustrate an automated tooling system 10 for gripping an object or other article 12 and moving the article. The automated tooling system 10 includes an arm 16 engageable with a mounting receiver 18 of a mounting assembly of an automated tooling system, for example, for a rail receiver system. The arm 16 includes a collar 20 and a pair of plasma ion nitrided pins 22 extending substantially parallel to the longitudinal axis of the arm 16 to engage and align the arm and the mounting receiver 18.

Prior to assembly, each pin 22 is plasma ion nitrided and includes a top flange 24 and a stem 26. The stems 26 are received in apertures 28 defined by the collar 20 and are engaged with the collar by press fit or by any other suitable manner. Plasma ion nitriding is a plasma supported thermochemical process. It can be achieved in any suitable commercial or other manner. Plasma ion nitriding of the pins may provide many benefits. For example, it increases hardness and wear resistance. It also causes generation of a hard layer that includes compressive stresses.

The arm 16 includes an open-ended front end 30, an open-ended rear end 32 and a generally cylindrical wall 34 that defines a cylindrical bore 36 that extends along the entire length of the arm. The arm 16 further includes an electrical power supply connector 40 disposed within the bore 36 at or otherwise adjacent the open rear end 32. The arm 16 also includes an electrical exit port 42 at or otherwise adjacent the open end of the front end 30 and wiring 44 in the form of one or more wires or cables connected or connectable to the electrical power supply connector 40. The electrical power supply connector 40 is connectable to a power source. The electrical exit port 42 may be in the form of an electric plug or the like for connecting the wiring 44 to the rest of the automated tooling system 10. The wiring 44 extends within the bore 36 of the arm 16 the entire length of the wiring from the electrical power supply connector 40 to the electrical exit port 42 so that the wiring is not exposed to the outside until it passes through the electrical exit port. The wiring 44 extends from the electrical power supply connector 40 to the electrical exit port 42 so that it is not exposed until it exits the open-ended front end 30. Thus, electricity travels through the wiring 44 from the power supply connector 40, the bore 36, the electrical exit port 42 and outside the front end 30 to a gripper 46 of the automated tooling system 10. Because it extends entirely within the bore 36, the wiring 44 is not exposed and does not interfere with the mounting of the arm 16 to the mounting receiver 18. In the illustrated embodiment, a protective metal tube 48 that surrounds the electrical exit port 42 is threadingly engaged with the front end 30 within the bore 36 to protect the electrical exit port.

The arm 16 may be constructed of steel or any other suitable metal or other material and may have any other suitable construction in accordance with other embodiments of the present disclosure. The automated tooling system 10, including the gripper 46 and the mounting receiver 18, may have any suitable construction and may be constructed of any suitable material.

The illustrated arm 16 and mounting receiver 18 can have any suitable complementary configuration that permits engagement of the arm and receiver. In the illustrated embodiment, for example, the arm 16 includes a pair of enlarged sections 50 separated by a flat face 52 that defines a recess 56. The arm 16 includes another face that defines a recess diametrically opposite the face 52 and recess 56 (not shown). The illustrated mounting receiver 18 includes a forward mounting portion 66 having a forward inner peripheral surface, a rearward mounting portion 68 having a rearward inner peripheral surface, and an intermediate open portion 70. The forward mounting portion 66 includes a pair of opposed spaced apart flanges 72 which define a top opening 74. The top opening 74 has a dimension greater than the recessed dimension of the recesses 56 of the arm 16 which permit passage between the flanges 72. The forward and rearward mounting portions 66 and 68 have inner dimensions approximately equal to the outer dimensions of the forward and rearward enlarged sections 50.

The illustrated arm 16 may also include a mechanical coding structure 90 including a pair of air connectors 92. The mechanical coding structure 90 is intended to ensure that the arm 16 is secured in the correct application. The air connectors 92 use pneumatics to provide a vacuum to enhance functions of the gripper 46. The wall 34 may include a flat face 94 for engaging the mechanical coding structure 90 and may define a pair of apertures 96 for receiving fasteners 98 to the mechanical coding structure to the wall.

The present disclosure in accordance with an embodiment provides pins 22 that are stronger and harder. There is minimal wear and, due to the plasma ion nitriding, the pins 22 are durable and dense with high hardness. The present disclosure in accordance with an embodiment provides internal wiring to ease the connectability of the arm 16 and mounting receiver 18 and extend the life of the arm.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. An arm engageable with a mounting receiver of an automated tooling system having a gripper, the arm comprising:
a wall defining a central bore extending the length of the arm, and at least one plasma ion nitrided pin engageable with the mounting receiver to engage the mounting receiver for aligning and receiving the mounting receiver.

2. The arm of claim 1 further including first and second ends and an electrical power supply connector positioned inside the bore adjacent the first end and wiring connected to the electrical power supply connector, the wiring extending unexposed within the bore from the electrical power supply connector to the second end to supply power to the gripper.

3. The arm of claim 2 further including an electrical exit port disposed at the second end, the wiring connecting the electrical power supply connector and the electrical exit port.

4. The arm of claim 3 further including a protective tube disposed about the electrical exit port at the second end.

5. The arm of claim 4 wherein the protective tube is threadingly engaged with the wall.

6. The arm of claim 1 wherein the arm further includes a collar, the at least one plasma ion nitrided pin secured to the collar.

7. The arm of claim 1 wherein there are two plasma ion nitrided pins and further including a collar, the two plasma ion nitrided pins secured to the collar.

8. An arm engageable with a mounting receiver of an automated tooling system having a gripper, the arm comprising:
at least pin engageable with the mounting receiver for aligning the arm, first and second ends, a wall defining a central bore extending the length of the arm, an electrical power supply connector disposed within the bore adjacent the first end, an electrical exit port disposed adjacent the second end, and wiring extending within the bore from the electric power supply connector to the electric port for providing power to the gripper.

9. The arm of claim 8 further including a protective tube disposed about the electrical exit port.

10. The arm of claim 9 wherein the protective tube is threadingly engaged with the wall.

11. The arm of claim 8 where the at least one pin is a plasma ion nitrided pin.

12. The arm of claim 11 wherein the arm further includes a collar, the at least one plasma ion nitrided pin secured to the collar.

13. The arm of claim 11 wherein there are two plasma ion nitrided pins and further including a collar, the two plasma ion nitrided pins secured to the collar.
